(19) United States
(12) Patent Application Publication
(10) Pub. No.: US 2011/0208691 A1
(43) Pub. Date: Aug. 25, 2011

(54) Accessing Large Collection Object Tables in a Database

(75) Inventor: Minxu Liu, Hangzhou (CN)

(73) Assignee: ALIBABA GROUP HOLDING LIMITED, Grand Cayman (unknown)

(21) Appl. No.: 12/995,262

(22) PCT Filed: Sep. 30, 2010
(86) PCT No.: PCT/US10/50830

§ 371 Date: Nov. 30, 2010

(30) Foreign Application Priority Data
Jan. 20, 2010 (CN) 201010002405.0

(51) Int. Cl. G06F 17/30

(52) U.S. Cl. 707/602; 707/E17.005; 707/E17.032

(57) ABSTRACT

The present disclosure provides a method and apparatus for accessing large object collection tables in a data warehouse, so that input-output complexities are reduced and the performance and responsiveness of the data warehouse are improved. In one aspect, a process may set up a new large object collection table by determining the object identification information of business activities occurring in a business period using the records in a business flow table. A sub-table from the original large object collection table may be generated based on the derived object identification information. The resulting sub-table may be incorporated into a new large object collection table that is partitioned according to business periods.

### CROSS REFERENCE TO RELATED PATENT APPLICATIONS

This application is a national stage application of an international patent application PCT/US10/50830, filed Sep. 30, 2010, which claims priority from Chinese Patent Application No. 201010002405.0 filed on Jan. 20, 2010, entitled “METHOD AND APPARATUS FOR ACCESSING LARGE OBJECT COLLECTION TABLES IN A DATABASE,” which applications are hereby incorporated in their entirety by reference.

### TECHNICAL FIELD

The present disclosure relates to information storage, and particularly relates to accessing large collection object tables that are stored in a data warehouse.

### BACKGROUND

A data warehouse (DW) is a subject-oriented, integrated, non-volatile, and time variant collection of data that is used to support strategic analysis of an enterprise, organization or network. A data warehouse is often used to store historical data through an extract, transform, and Load (ETL) process, as well as generate business reports. ETL distributes data from heterogeneous data sources such as relational databases, graphic data files, etc. These data are extracted to a temporary intermediate layer, and are then cleaned, transformed and integrated. Finally, the data are loaded into the data warehouse, where the data becomes the source for business reporting, Online Analysis Processing (OLAP), and data mining ETL is usually run at night to process large volume data of the enterprise to form KPI (Key Performance Indicators) that are loaded into business reports.

Typically, in some e-commerce sites, the data warehouse has user and commodity tables. The user table in the data warehouse stores all the user attribute information, in which each record correlates to a user, and each field correlates to a certain user attribute. Generally, a user table is one of the largest tables in the data warehouse. The commodity table in the data warehouse stores all the commodity attribute information. Each record in the commodity table correlates to a commodity, and each field correlates to a certain commodity attribute. Generally, the commodity table is also one of the largest tables in the data warehouse. Accordingly, since the user table and the commodity table contain a large number of records, the storage space for storing the tables may reach terabyte (TB) level. Further, more than half of the tasks of the data warehouse are to access the user table and the commodity table, and obtain certain attribute information of corresponding objects in the tables. Because these two tables are so large (their actual sizes may be different), allocating hardware resources to process these tables can be difficult. On the other hand, a special feature of these two tables is that the objects contained in them are complete and permanently stored. The ETL process generally scans the entire user table and the entire commodity table. However, when there is more than one process scanning the user table and the commodity table, the input-output in the data warehouse becomes more complex, causing the performance and response of the data warehouse to slow down.

### SUMMARY OF THE DISCLOSURE

The present disclosure provides methods and apparatuses for accessing large object collection tables in the data warehouse. The methods and apparatuses optimize input to and output from the data warehouse caused by large object collection tables.

In one aspect, a method of accessing data from a data warehouse includes generating a large collection table. The process for generating a new large collection table includes determining the object identification information of the business activities occurring in a business period based on business flow records in a business flow table. Based on this object identification information, a sub-table from an original large object collection table is generated. The resulting sub-table is incorporated into a new large object collection table that includes a plurality of business period partitions.

In another aspect, accessing the new large object collection table includes determining business period information corresponding to a designated time. The one or more business period partitions that correspond to the business period information in the new large object collection table are then accessed.

In an additional aspect, the object identification information of the business activities occurring in a current business period is determined from business flow records in a business flow table. The determination includes extracting all the object identification information from business flow records for the current business period in the business flow table, and reprocessing the extracted object identification information to verify that the extracted object identification information is from the business activities that occurred in the business period.

Further, the original large object collection table includes object records corresponding to the object identification information, and each object record includes the respective business period information and the respective attributes of the object in the original large object collection table. Moreover, the object identification information may include object identifier (ID) and object name.

In one implementation, the large object collection table can be a commodity table, and each object is a commodity. In another implementation, the large object collection table can be a user table, and each object is a user. In an additional implementation, each partition in the new large object collection table corresponds to a hard drive.

In a further aspect, the accessing of the new large object collection table uses an extract, transform, and load (ETL) process, in which the business period information corresponding to the designated time period is determined, and the one or more business period partitions corresponding to the business period information in the new large object collection table are then accessed.

In yet another aspect, the present disclosure provides an apparatus for accessing data from a data warehouse. The apparatus includes a determination module that determines the object identification information of business activities that occurred in a business period based on the business flow records in a business flow table. The apparatus further includes a generation module that generates one or more sub-tables from the original large object collection table based on the object identification information, and to incorporate the one or more sub-tables into a new large object collection table that has a plurality of business period partitions. The apparatus further includes an access module that accesses the new large object collection table determines the business period information corresponding to a designated time period, and accesses the one or more business period partitions that corresponds to the business period information in the new large object collection table.

In one implementation, the determination module includes an extraction sub-module that extracts the object identification information from the business flow records in the business flow table. The determination module also includes a re-process sub-module that reprocesses extracted object identification information to verify that the object identification information corresponds to business activity occurring in the current business period. Each of the sub-table generated by the generation module includes the object record corresponding to the object identification information. Each object record comprises business period information and attributes of a respective object in the original large object collection table.

In another implementation, the access module is used to further determining the corresponding business period information during the time period designated to an ETL task.

In still another aspect, the present disclosure provides another method for accessing data from a data warehouse. The method includes determining object identification information of the business activities in each of a plurality of business periods based on business flow records in a business flow table. The method further includes generating one or more sub-tables for each business period from an original large object collection table based on the object identification information. As such, each of the sub-tables is correlated with a respective business partition in the plurality of business periods. The method additional includes accessing at least one sub-table in the one or more business period partitions that corresponds to the business period information.

In an additional aspect, the present disclosure provides another apparatus for accessing data from a data warehouse. The apparatus includes a determination module that determines object identification information of business activities occurring in each of a plurality of business periods based on business flow records in each of a plurality of business flow tables. The apparatus further includes a generation module that generates one or more sub-tables from an original large object collection table based on the object identification information, so that each sub-table is correlated with a respective business period partition in the plurality of business periods. The apparatus also includes an access module that accesses the original large object collection table. The access module is used to determine the business period information corresponding to a designated time period, and access at least one sub-table in the one or more business period partitions that corresponds to the business period information.

The present disclosure provides an additional method and an additional apparatus for accessing a large object collection table from a data warehouse. Based on the business flow records in the business period, the object in business activities occurring in the current business period is determined, and a sub-table from the original large object collection table is generated. The resulting sub-table is incorporated into a new large object collection table in accordance with business period partitions. Accordingly, the sub-table in the new large object collection table can be stored in a business period partition. Because of the new large object collection table, the ETL process only accesses the business period partitions corresponding to a designated time period. This reduces the input-output complexity of the data warehouse caused by the large object collection table. Accordingly, the performance and responsiveness of the data warehouse is improved.

The present disclosure provides another additional method and yet another additional apparatus for accessing a large object collection table from a data warehouse. Based on the business flow records in the business period, the one or more objects in the business activities occurring in the current business period is determined, and one or more sub-tables from the original large object collection table are generated. The one or more resulting sub-tables are incorporated into a new large object collection table stored according to business period partitions. Therefore, the unparsed original large object collection table can be parsed into multiple sub-tables according to business periods. With multiple sub-tables, the ETL process only accesses the sub-tables of the business period that corresponds to the designated time period. This reduces the input-output complexity of the data warehouse caused by a large object collection table. Accordingly, the performance and responsiveness of the data warehouse is improved.

The other features and advantages of this present disclosure will be described in this disclosure. These features and advantages can also be partly understood from the disclosure or through the implementation of this disclosure. The purpose and other advantages of this present disclosure can be obtained from the exposition, claims, and diagrams.

### DESCRIPTION OF DRAWINGS

FIG. 1 shows a diagram of the establishment process of a new large object collection table according to the first embodiment of the present disclosure;

FIG. 2 shows a diagram of an ETL task implementation according to a first embodiment of the present disclosure;

FIG. 3 shows a diagram of a method of accessing a commodity table according to the first embodiment of the present disclosure;

FIG. 4 shows a diagram of an apparatus for accessing a large object collection table according to the first embodiment of the present disclosure;

FIG. 5 shows a diagram of a process for generating sub-tables according to a second embodiment of the present disclosure;

FIG. 6 shows a diagram of ETL task implementation according to the second embodiment of the present disclosure;

FIG. 7 shows a diagram of apparatus for accessing a large object collection table according to the second embodiment of the present disclosure.

### DETAILED DESCRIPTION

The present disclosure provides methods and apparatuses for accessing large object collection tables in a data warehouse. The methods and apparatuses are used to reduce the complexity of data input-output at a data warehouse caused by large object collection tables. The reduction in input-output complexity may improve the data warehouse's performance and responsiveness.

The embodiment of the present disclosure may use large object collection tables to store business data, such as user data and commodity data. In a large object collection table, each record (each line) corresponds to an object, and each field (each column) corresponds to a certain attribute of the object. In other words, in the large object collection table, each object has a corresponding record in the table, and each record contains all attribute values of the object. For example, in the case of a large object collection table that is a commodity table, as shown in Table 1, each object is a commodity. Each commodity corresponds to a record, and each record contains all the attributes of the commodity, such as a commodity identifier (ID), a brand name, a price, a quantity, etc.

TABLE 1

| Commodity ID | Brand | Quantity | Price |
|---|---|---|---|
| 1 | AAA | S₁ | Xxx |
| 2 | BBB | S₂ | Xxx |
| . . . | . . . | . . . | . . . |
| N | ZZZ | S_{N} | xxx |

Similarly, in the case when a large collection table is a user table, as shown Table 2, each object in the table is a user. Each user has a corresponding record in the table, and each record contains all the attributes of a user, such as a user identifier (ID), a name, an age, a gender, etc.

TABLE 2

| User ID | Name | Age | Gender |
|---|---|---|---|
| 1 | Zhang | xx | M |
| 2 | Li | xx | F |
| . . . | . . . | . . . | . . . |
| 3 | Wang | xx | M |

The following drawings describe example embodiments of this present disclosure. It should be understood that these example embodiments are only used for describing and explaining the present disclosure. These example embodiments neither limit nor contradict the present disclosure under any circumstances. The exemplary embodiments of the present disclosure and their features may be combined.

### Embodiment 1

Based on the introduction of the large object collection table, the present disclosure provides an exemplary technique for accessing the large object collection tables from the data warehouse. Further the exemplary technique may comprise two processes: (1) generating the new large object collection table and (2) accessing the new large object collection table, which includes executing an ETL process.

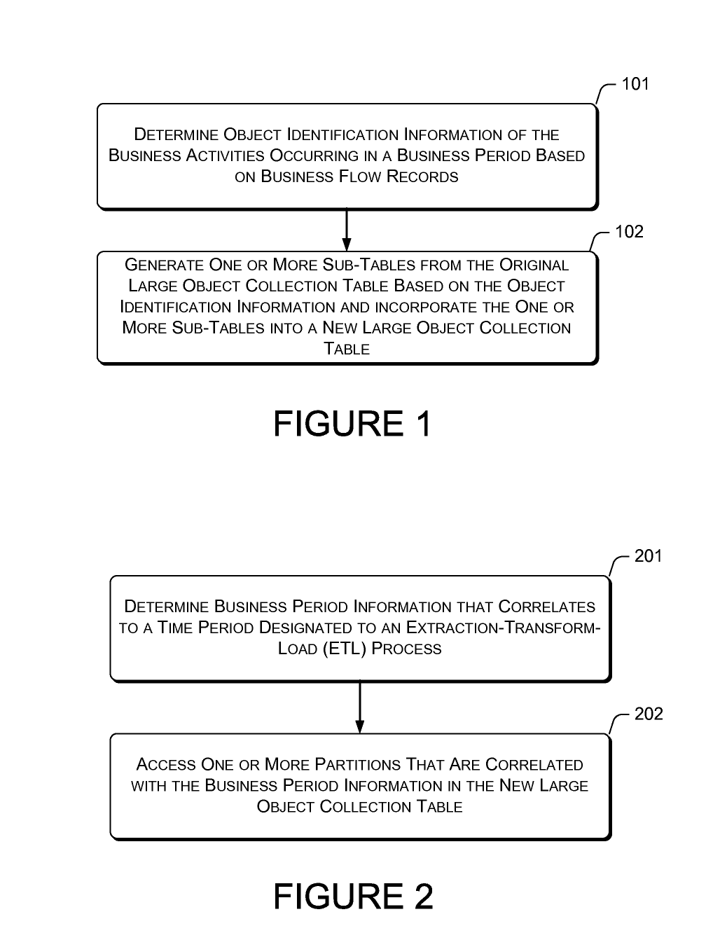

FIG. 1 shows an exemplary process for generating a new large object collection table.

At 101, the object identification information of business activities occurring in a business cycle is determined from the business flow records in a business flow table.

The business flow table is one of the largest tables in the data warehouse. A business flow table and a large object collection table, however, are not the same. A business flow table may contain time attribute information, which can be store in daily partitions. Further, in the business flow table, each business activity may correlate to a business flow record. Each business flow record may include a date, object identification information, type of business activity, etc.

In the implementation of 101, the process may determine the object identification information of the one or more objects processed during a business period using the following steps: extracting the object identification information from the corresponding business flow records of all the objects in the business flow table that are processed during the business period, and reprocessing the extracted object identification information to verify that the object identification information of the objects correlate with business activities that occurred during the business period. The business period can be selected as one day, one week, one month, one year, etc. It may be set according to the actual scenario or requirements.

At 102, based on this object identification information, one or more sub-tables from the original large object collection table are generated. The resulting one or more sub-tables are incorporated into a new large object collection table and stored based on business period partitioning.

In the implementation of 102, each of the one more sub-tables may be generated by extracting the records of the large object collection table corresponding to the object identification information. Each sub-table includes the object record corresponding to the object identification information, and each object record includes attributes of a corresponding object from the large object collection table, as well as the business period information designating the associated business period. Specifically, if the business period is a day, the “year/month/day” format can be used to designate the associated business period. If the business period is a month, “year/month” format can be used to designate the associated business period.

In some embodiments, different data (records) that have been partitioned according to different business periods can be stored in different hard drive according to respective business period partitions. When ETL accesses the time data, it only needs to scan the hard disk corresponding to the partition. There is no need to scan all the data. During implementation, a field in the business period of the new large object collection table can be designated as the partition key, which can be stored by partition. A partition key includes a key name and key value. The key name can be any specific “business period name”, and the key value can be any specific “business period information value” to indicate a particular business period.

FIG. 2 shows an exemplary process for accessing a new large object collection table using ETL.

At 201, the business period information that correlates to a time period designated to an ETL process is determined. Because the new large object collection table is partitioned based on business periods, each particular business period is correlated with a particular set of the business period information. Thus, the business period information can be determined based on the particular business period during the given time period. During implementation, each time period may correlate to one or more pieces of business period information.

At 202, one or more business period partitions that are correlated with corresponding business period information in the new large object collection table is accessed via an ETL process. With the use of the ETL process, a business report can be generated by accessing the one or more partitions that correspond to one or more business periods in the time period designated to the ETL process. Needless to say, business reports generated based on such access results are identical with the business reports generated based on the access results in a conventional implementation of ETL.

Understandably, since the new large object collection table is continuously updated based on one or more new business periods, the large object collection table accessed by the ETL process is the newest (e.g., most updated) large object collection table.

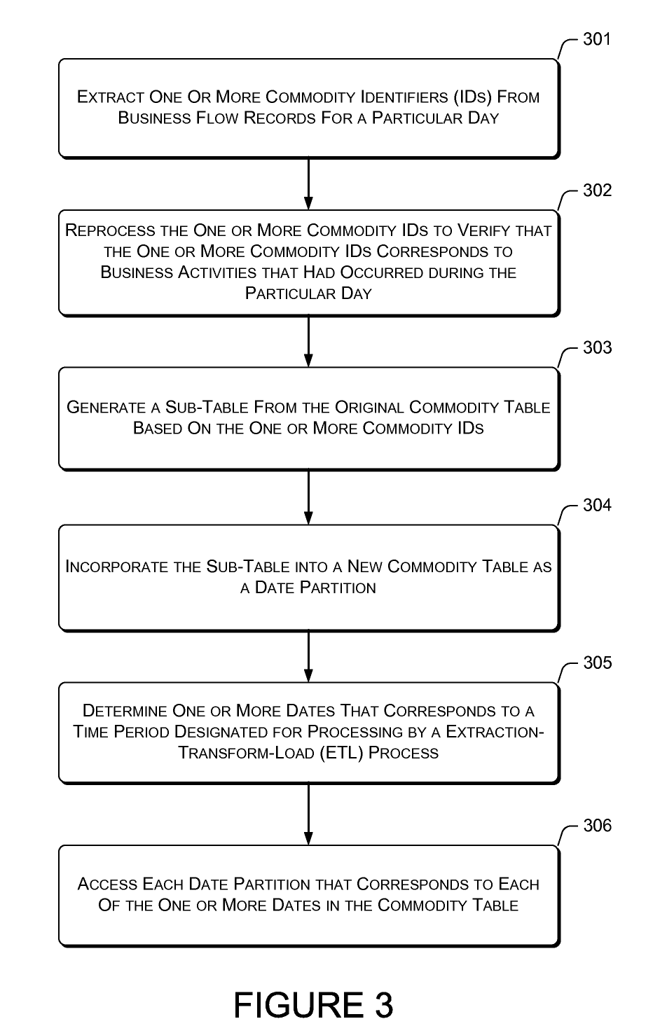

The following detailed description of commodity table illustrates an exemplary method of accessing a large object collection table. In such embodiments, the business period is “one day”, and the object identity information is “commodity ID”. For the particular day, the generation (update) process of a new commodity table is shown in FIG. 3.

At 301, one or more Commodity IDs from business flow records for the particular day that are in the business flow table are extracted;

At 302, the one or more extracted Commodity IDs are reprocessed to verify that the one or more commodity IDs correspond to business activities that had occurred during the particular day. The one or more commodity IDs of the business activities during that day are formed into a list, which can become the commodity ID list.

At 303, a sub-table from an original commodity table is generated based on the one or more commodity IDs. The sub-table includes the commodity records that correspond to the commodity IDs. Each commodity record includes the date, as well as all the attributes of the commodity from the original commodity table.

For example, assume that based on the business flow record on a specific day, Dec. 24, 2009, the commodity IDs are determined to be 1, 2 . . . and N. Then the sub-table of the original commodity table (shown Table 1), is as shown in Table 3. The sub-table includes the commodity records corresponding to the commodity IDs (1, 2 . . . and N). Each record includes the date (20091224), as well as all the attributes of the commodity from the original commodity table. For example, for the commodity with the commodity ID “2”, the corresponding commodity record includes 20091224 (date), all the attributes of the commodity, such as BBB (Brand), S₂ (product number), and xxx dollars (price). In other words, the sub-table includes business date field and all other attribute fields in the original commodity table.

TABLE 3

| Date | Commodity ID | Brand | Product number | Price |
|---|---|---|---|---|
| 20091224 | 1 | AAA | S₁ | $ xxx |
| 20091224 | 2 | BBB | S₂ | $ xxx |
| 20091224 | N | ZZZ | S_{N} | $ xxx |

At 304, the resulting sub-table is incorporated into the new commodity table as a date partition. In the new commodity table, the date becomes the partition key, so the commodities for the business activities of the particular day are stored in the same business period partition (e.g., hard disk) of the new commodity table.

Based on the new commodity table, the implementation of the ETL task comprises the following:

At 305, an ETL process determines the one or more dates corresponding to a time period designated for processing by ETL.

At 306, each date partition that corresponds to each of the one or more dates in the new commodity table is accessed.

In one example, assuming that the ETL process is assigned a certain date (Dec. 24, 2009), ETL determines the date as 20091224, and then accesses the partition corresponding to 20091224. In another example, assuming that the designated time period of process is Dec. 22, 2009 to Dec. 24, 2009, the ETL process determines that the business date information as 20091222, 20091223, and 20091224. The ETL process then accesses the partitions corresponding to 20091222, 20091223, and 20091224. Since ETL only needs the partition data corresponding to the one or more particular dates, and there is no need to access all the data, the accessing speed is therefore faster.

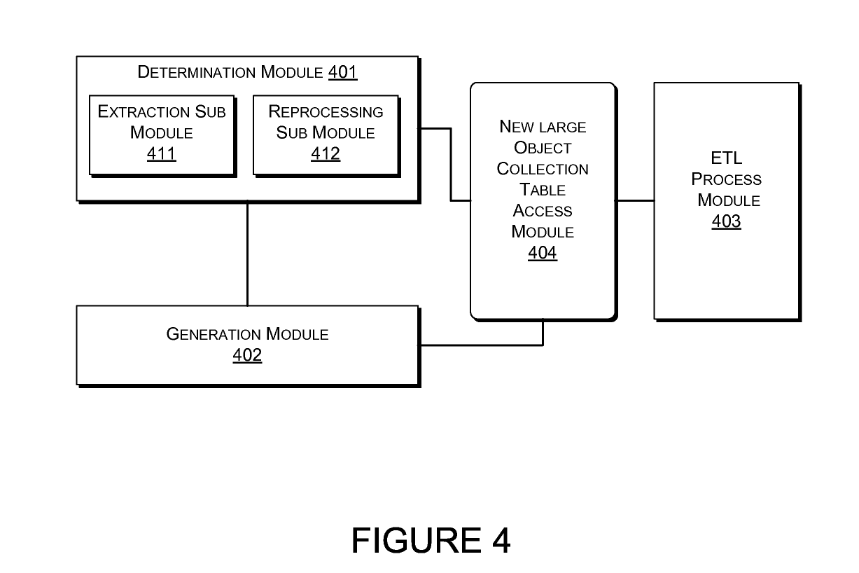

Based on the same technology, the present disclosure also provides an apparatus for accessing a large object collection table from data warehouse, as shown in FIG. 4. The apparatus includes a determination module 401 that determines the object identification information of the business activities occurring in each business period from business flow records in the business flow table.

The apparatus may also include a generation module 402 that generates a sub-table from an original large object collection table based on the object identification information. The resulting sub-table is incorporated into a new large object collection table based on business period partitions.

An access module 404 is employed to access the new large object collection table. The access module 404 determines the business period information corresponding to the designated time period, and accesses the partitions corresponding to the business period information in the new large object collection table. The access module 404 may be part of an ETL process module 403. The ETL process module 403 is used for determining the corresponding business period information during a time period designated for ETL processing, and accessing the partitions corresponding to the business period information in the new large object collection table.

In some implementations, the determination module 401 may comprise additional modules. The additional modules may include an extraction sub-module 411, which is used for extracting object identification information from business flow records in the business flow table for each business period. The additional modules may also include a reprocessing sub-module 412, which is used for reprocessing the extracted object identification information to verify that the object identification information corresponds to the business activities occurring in the current business period.

Moreover, each of the sub-tables generated from the original large object collection table by the generation module 402 includes a record corresponding to the respective object identification information. Each record includes the business period information, as well as all other attributes from the large object collection table.

The first exemplary implementation above provides a method and apparatus for accessing large object collection table in the data warehouse. Based on the business flow records, the implementation determines the one or more objects in the current business period and generates a sub-table from the original large object collection table. The resulting sub-tables are incorporated into a new large object collection table in accordance with one or more business period partitions. Accordingly, the sub-tables can be stored based on the one or more business period partition. With the new large object collection table, the ETL process may only needs to access the business period partitions corresponding to the designated time period. This reduces the complexity associated with input-output data to the data warehouse. Accordingly, the performance and responsiveness of the data warehouse is improved.

### Embodiment 2

The present disclosure provides another exemplary embodiment of an exemplary technique for accessing a large object collection table. The exemplary technique comprises a process for generating one or more sub-tables from an original large object collection table and an ETL process.

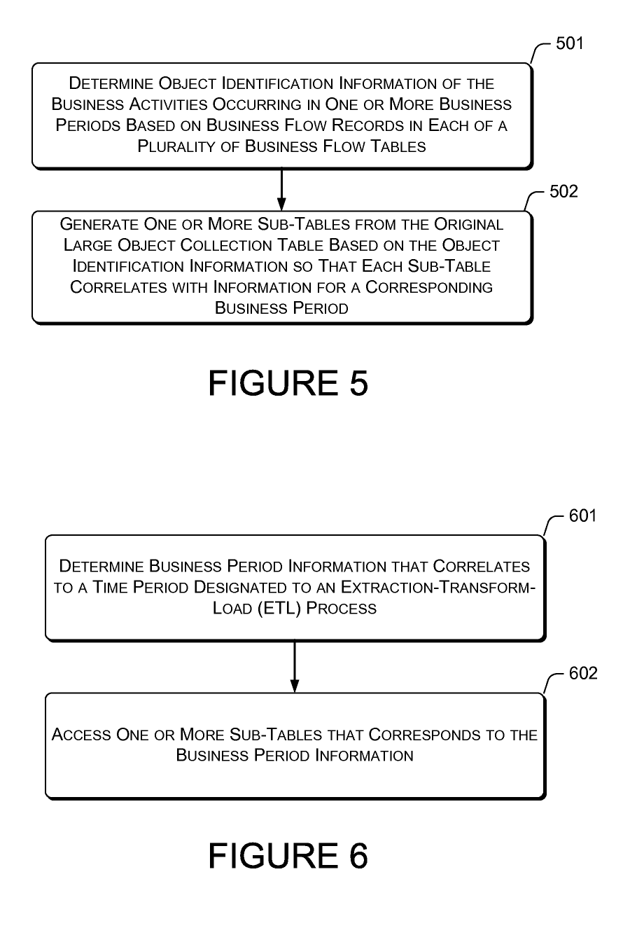

FIG. 5 shows an exemplary process of generating a large object collection table.

At 501, the object identification information of the business activities occurring in the one or more business periods is determined using the business flow records in each of a plurality of business flow tables. The implementation of 501 may be similar to the implementation of 101.

At 502, one or more sub-tables from the original large object collection table is generated based on the object identification information. Each of the resulting sub-table is correlated with information for a corresponding business period.

In one implementation of 502, the aforementioned “one or more sub-tables from the original large object collection table is generated, based on the object identification information” may be implemented in a similar manner as the implementation of 102. The aforementioned “each of the resulting sub-table is correlated with corresponding current business period information” can be achieved through the correlation of each sub-table name with the related business period information. The correlation of each sub-table and its corresponding business period information can be achieved by setting up a relationship between each sub-table name and the corresponding business period information.

As shown in FIG. 6, using ETL as an example, a method of accessing a sub-table of the original large object collection table includes a number of actions as described below.

At 601, the corresponding business period information during a time period designated to an ETL process is determined The implementation 601 may be similar to the implementation of 201.

At 602, one or more sub-tables corresponding to the business period information is accessed. With respect to a user of the ETL process, a business report can be generated by accessing the one or more sub-tables of the corresponding business period during the time period designated to ETL process. Needless to say, business reports generated based on the access results are identical to the ones generated based on the access results in a conventional ETL process. Understandably, the sub-tables are continuously updated, and the ETL process can access all of these sub-tables.

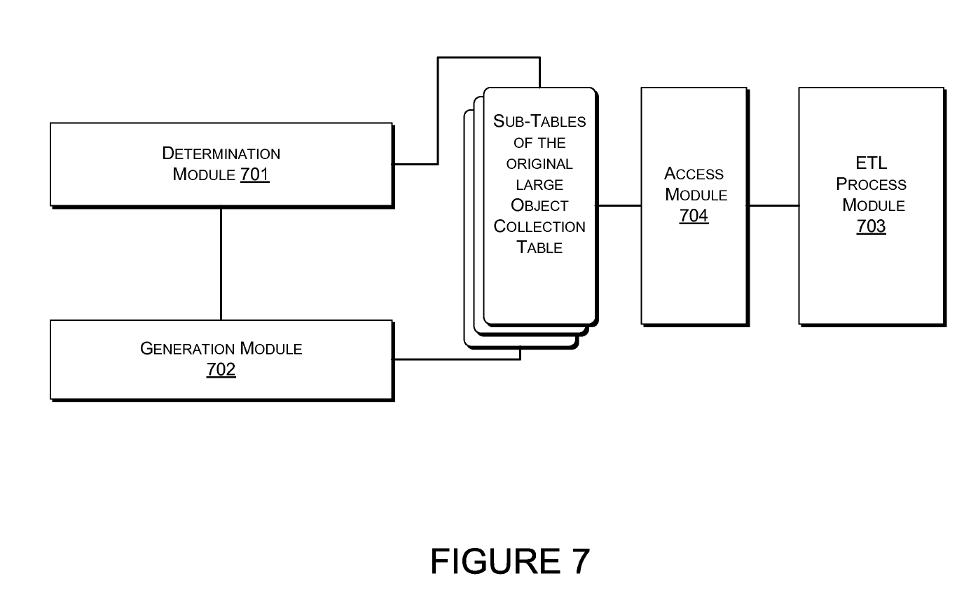

With this technology, the present disclosure also provides an apparatus for accessing large object collection table from data warehouse. As shown in FIG. 7, the apparatus includes a determination module 710 that is used for determining the object identification information of the business activities occurring in the current business period using the business flow records in the business flow table. Further, a generation module 702 is used for generating on or more sub-tables from the original large object collection table using the object identification information, and correlating the resulting sub-table with current business period information.

An access module 704 for the original large object collection table is used for determining the business period information corresponding to the designated time period, and accessing the business period partitions of the original large object data collection table that correspond to the business period information. The access module 704 may be part of the ETL process module 703. The ETL process module 703 uses ETL to determine the corresponding business period information during the time period designated to the ETL, and to access the partitions corresponding to the business period information in the new large object collection table.

The second exemplary implementation above provides a method and apparatus for accessing large object collection table from data warehouse. Based on the business flow records in the business period, the implementation determines the one or more objects in the business activities occurring in the current business period, and generates one or more sub-tables from the original large object collection table. Since there is no partition in the original large object collection table, the original large table can be parsed into multiple sub-tables based on the business period. Because of the multiple sub-tables, the ETL process only needs to access the business period sub-tables corresponding to the designated time period. This reduces the input-output difficulty of the data warehouse caused by the large object collection table. Accordingly, the performance and responsiveness of the data warehouse is improved.

The present disclosure provides a method, apparatus, or computing program product. Therefore, the present disclosure can be implemented using software, hardware or a combination of both. Moreover, the present disclosure can use one or more among the following computer processing products, available computer program code, available computer-readable storage media (disk storage, CD-ROM, optical storage, etc.).

The description of methods, devices, and computer program product in this present disclosure can be referred to the figures or/and diagrams. It should be understood that each process or block, as well as the combinations of processes and/or blocks in the figures and/or diagrams can be implemented based on the computer process instructions. These computer process instructions can be provided to general-purpose computers, special-purpose computers, embedded processor or other programmable data processing equipment used for producing a machine processor. The instruction generated from the process execution of the computer device or other programmable data processing equipment is used by the apparatus to implement one or more processes in the figure and/or the specific function in one or more blocks in the diagram.

These computer program instructions may also be stored in a computer or other programmable data-processing apparatus. This instruction stored in this programmable data-processing apparatus can make a product that includes the instruction apparatus. The instruction apparatus can be implemented as a function in one or more processes in the flow chart and/or in one or more blocks in the diagram.

The computer program instruction can also be loaded to a computer or other programmable data processing apparatus. This makes the computer or other programmable apparatus perform a series of steps through a computer implementation process. Therefore, the instructions performed by the computer or other programmable apparatus provide the steps used for implementing as a function in one or more processes in the flowchart and/or one or more blocks in the diagram.

Although the disclosure has described an optimal exemplary implementation; however, a person of ordinary skill in the art, who learns the basic innovative concept, can make other modifications and variations in these implementations. Therefore, all claims wish to be interpreted in the light of the optimal exemplary implementation as well as the changes and modifications within the disclosure's scope.

Of course, the person of ordinary skill in the art can alter or modify the present disclosure without departing from the spirit and the scope of the disclosure. Accordingly, it is intended that the present disclosure covers all modifications and variations which falls within the scope of the claims of the present disclosure and their equivalent.

What is claimed is:

1. A method, comprising:
determining object identification information of business activities occurring in a business period based on business flow records in a business flow table;
generating one or more sub-tables from an original large object collection table based on the object identification information; and
incorporating the one or more sub-tables into a new large object collection table that includes a plurality of business period partitions.

2. The method of claim 1, further comprising:
determining business period information corresponding to a designated time period; and
accessing the one or more business period partitions in the new large object collection table that correspond to the business period information.

3. The method as recited in claim 1, wherein the determining the object identification information of the business activities comprises:
extracting all the object identification information from business flow records of the business period in the business flow table; and
reprocessing the extracted object identification information to verify that the extracted object identification information is from the business period.

4. The method as recited in claim 1, wherein the original large object collection table comprises one or more object records corresponding to the object identification information, each object record including respective business period information and attributes of a respective object in the original large object collection table.

5. The method as recited in claim 3, wherein the original large object collection table comprises one or more object records corresponding to the object identification information, each record including respective business period information and attributes of a respective object in the original large object collection table.

6. The method as recited in claim 1, wherein the object identification information includes an object identifier (ID) and an object name.

7. The method as recited in claim 1, wherein the original large object collection table is either a commodity table that includes one or more commodity objects or a user table that includes one or more user objects.

8. The method as recited in claim 1, wherein each business period partition in the new large object collection table is stored on a corresponding hard drive.

9. The method as recited in claim 2, wherein the accessing includes accessing the one or more business partitions in the new large object collection table using an extract, transform, and load (ETL) task, wherein the method further comprises:
determining the business period information of a time period designated to the ETL; and
accessing the one or more business period partitions corresponding to the business period information in the new large object collection table.

10. An apparatus to access data in a data warehouse, comprising:
a determination module that determines object identification information of business activities occurring in a business period based on business flow records in a business flow table;
a generation module that generates one or more sub-tables from an original large object collection table using the object identification information, and incorporates the one or more sub-tables into a new large object collection table having a plurality of business period partitions; and
an access module that accesses the new large object collection table, determines the business period information corresponding to a designated time period, and accesses one or more of the business period partitions that correspond to the business period information in the new large object collection table.

11. The apparatus as recited in claim 10, wherein the determination module comprises:
an extraction sub-module that extracts the object identification information from the business flow records in the business flow table; and
a reprocess sub-module that reprocesses the extracted object identification information and verifies that the object identification information corresponds to business activities occurring in the business period.

12. The apparatus as recited in claim 10, wherein each of the one or more sub-tables includes a respective object record corresponding to the object identification information, each object record including respective business period information and attributes of a respective object in the original large object collection table.

13. The apparatus as recited in claims 11, wherein each of the one or more sub-tables includes a respective object record corresponding to the object identification information, each object record including respective business period information and attributes of a respective object in the original large object collection table.

14. The apparatus as recited in claim 10, wherein the access module further determines the corresponding business period information during a time period designated to an extract, transform, and load (ETL) task.

15. A method, comprising:
determining object identification information of business activities occurring in each of a plurality of business periods based on business flow records in a business flow table;
generating one or more sub-tables for each business period from an original large object collection table based on the object identification information, each sub-table being correlated with a respective business period partition in the plurality of business periods;
determining one or more business period partitions that correspond to business period information in an access request; and
accessing at least one sub-table in the one or more business period partitions that correspond to the business period information.

16. An apparatus to access data in a data warehouse, comprising:
a determination module that determines object identification information of business activities occurring in each of a plurality of periods based on business flow records in each of a plurality of business flow tables;
a generation module that generates one or more sub-tables from an original large object collection table based on the object identification information, each sub-table correlated with a respective business period partition in the plurality of business periods; and
an access module that accesses the original large object collection table, determines business period information corresponding to a designated time period, and accesses at least one sub-table in one or more business period partitions that correspond to the business period information.
